(19) United States
(12) Patent Application Publication
(10) Pub. No.: US 2015/0148029 A1
(43) Pub. Date: May 28, 2015

(54) RE-TRANSMISSION OF MANAGEMENT INFORMATION IN A MANAGEMENT NETWORK OF A COMMUNICATIONS SYSTEM

(71) Applicant: NOKIA SOLUTIONS AND NETWORKS OY, Espoo (FI)

(72) Inventor: Lucian Hirsch, Munich (DE)

(21) Appl. No.: 14/405,895

(22) PCT Filed: May 28, 2013
(86) PCT No.: PCT/EP2013/060949

§ 371 Date: Dec. 5, 2014

(30) Foreign Application Priority Data
Jun. 6, 2012 (EP) PCT/EP2012/060721

(51) Int. Cl. H04W 24/10; H04L 1/08

(52) U.S. Cl. CPC H04W 24/10; H04L 1/08
USPC 455/422.1

(57) ABSTRACT

Disclosed are a system, methods, devices and computer program products for re-transmission of management information in a management network for monitoring and controlling a communications system. The management network comprises managers and agents configured as devices on different management levels. Management information is transmitted as event reports between these devices of the management network and event reports transmitted to a manager by an agent (EMS) are temporarily stored by the agent for future re-transmissions, the manager recognizes a loss of one or more event reports, identifies the lost event reports and requests re-transmission of the lost event reports by sending a request to the agent, the agent retrieves the requested event reports from storage and re-transmits them to the requesting manager.

### FIELD OF THE INVENTION

The present application relates generally to a system, methods, devices, computer programs and computer program products for re-transmission of management information in a management network for monitoring and controlling a communications system.

### BACKGROUND ART

The principles of a management network, also referred to as TMN principles (TMN: Telecommunications Management Network), define several management layers for the management of a communications system—for example, a mobile communications system —, whereby each layer, with the exception of the topmost and bottommost layer, has a dual function. In the managing system, each level, apart from the bottommost one, exercises a manager function for the next level down. In the managed system, each level, except for the topmost one, is given an agent function for the next layer up.

The ITU-T Standards of the Series X.73x define different systems management functions for the supervision of telecommunications networks, which can be used by application processes in a centralised or decentralised management environment.

The manager-agent communication is made via so-called management interfaces or manager-agent interfaces, which can be identified in an object-oriented environment by means of a communications protocol (e.g. CMIP (Common Management Information Protocol according to ITU-T X.711) or CORBA (Common Object Request Broker Architecture)) and an object model.

Such interfaces exist, for example, between, on the one hand, the element management level and, on the other hand, the network element level. An example for network devices to this interface (OMC-BSS interface) is given by the operation and maintenance centres (OMC) on the element management level side and the base stations, for example, of the base station system (BSS) in a GSM mobile radio network on the network element level. The base stations of a second generation GSM network are referred to here by way of example. In the scope of this invention base stations of other communications networks can also be affected, for example node B of a UMTS mobile network (UMTS Universal Mobile Telecommunication System) or radio access points of a WLAN system (WLAN Wireless Local Area Network) for example to one of the IEEE 812.11-standards.

Document US 2003/162537 discloses a method for distributing management information in a management network for monitoring and controlling a communication system, with the management network comprising managers “NMC” and agents “OMC1-3” configured as devices on different management levels, with management information being transmitted as event reports between these devices of the management network.

Management interfaces or manager-agent interfaces do exist, but especially also between, on the one hand, the network management level and, on the other hand, the network element management level. An example for network devices to these interfaces (NMC-OMC interfaces or NM-EM interfaces) is given by the network management centres (NMC) on the network management level side and the operation and maintenance centres (OMC) on the element management level e.g. in the GSM mentioned or in another mobile radio or fixed telecommunication network.

In summary, it can be noted that complex telecommunication networks (such as, for example, mobile networks) commonly use management hierarchies in which element managers (OMC systems) play the agent role and network managers (NMC systems) play the manager role. Operations are carried out and management information is processed and stored both in network management centres (NMC) as well as in operation and maintenance centres (OMC).

In a multi-manager environment, each agent must be able, if need be, to handle requests from several managers, which requests run in parallel to each other. A manager can only optimally fulfill its control function if all relevant event reports from the subordinate agents are received. Under normal conditions, i.e. when the communication between an agent and the higher managers functions correctly, this occurs via a so-called event reporting mechanism. The task of said event reporting mechanism is to route to the manager only those event reports which satisfy certain filter criteria, pre-defined by each manager.

Ensuring the consistency of management information, even when individual NM-EM interfaces fail, is very important for an efficient network operation, especially in a hierarchical multi-manager configuration.

On NM level the loss of management information sent by an agent in the EMS (or—seldom—directly by managed NEs) may occur due to different reasons, for example because the use of management interface protocols (e.g. “Simple Network Management Protocol”, SNMP) is based on unreliable connectionless transport protocols (e.g. UDP), because of temporary NMS-EMS communication interruptions due to network problems or because of temporary NMS downtimes.

In current literature, the aspects of re-transmission of lost events on management interfaces usually are described concerning the drawbacks of unreliable protocols, in most cases with regard to a single NMS or—when dealing with multiple NMS—by recommending the usage of a dedicated event buffer by the agent, for each registered NMS. This leads to multiple storage of same management information in the agent, as events may be forwarded to more than one NMS.

In current 3GPP-defined “Delta Synchronization IRP”, one NMS cannot flexibly request the Agent to re-transmit only some event reports like the event reports occurred after the last received one or the ones lost between two received event reports. This leads to long synchronization times and interface payload.

### SUMMARY

In consideration of the above, an object of the invention is to overcome one or more of the above drawbacks. In particular, examples of the present invention provide methods, devices, a system, and a related computer program product for optimizing time needed for synchronisation of all or specific types of management information, reduction of interface payload due to re-transmissions and reduction of storage consumption for buffering.

According to a first embodiment of the present invention, there is provided a method for re-transmission of management information in a management network for monitoring and controlling a communications system, whereby the management network comprises managers and agents on different management levels, management information is transmitted as event reports between these devices of the management network, and event reports transmitted to a manager by an agent are temporarily stored by the agent for future re-transmissions, the manager recognizes a loss of one or more event reports, identifies the lost event reports and requests re-transmission of all or dedicated types of the lost event reports by sending a request to the agent, and the agent retrieves the requested event reports from storage and re-transmits them to the requesting manager.

A consecutively increasing sequence identification number, which is unique for each manager, may be assigned to an event report and transmitted with the event report to the manager.

Recognizing a loss of one or more event reports may comprise detecting a gap in the sequence of sequence identification numbers received from the agent and identifying lost event reports may comprise deriving the sequence numbers of lost transmission reports from the gap.

A request for re-transmission may comprise indicating the sequence identification numbers of lost event reports.

Alternatively requesting may comprise indicating the sequence identification number of the last received event report after a communication failure.

Requesting may also comprise indicating a subset, type or class of event reports which shall be re-transmitted or a subset, type or class of event reports which shall not be re-transmitted.

In an aspect of the invention, the agent stores the event report in an event buffer storage element, once for multiple managers to which the event report has been transmitted, whereby the event buffer storage element comprises a sequence identification number for each manager to which the event report has been transmitted.

Event buffer storage elements may be managed in a data structure with pointers to the newest and oldest elements.

The data structure may be a ring buffer structure, whereby a new event report is stored in the element after the oldest element is overwritten cyclically, when the ring buffer is full.

A new event report may be stored in a swap buffer element instead of overwriting the oldest element, while the event report of the oldest element is requested for re-transmission by a manager and the re-transmission is not yet completed.

According to a second embodiment of the invention, there is provided a network device functioning as an agent in a management network for monitoring and controlling a communications system, whereby the network device is designed for at least one manager-agent relationship with a manager device of one network management level and the network device as agent of another management level. The network device is configured for transmitting management information as event reports to devices of the management network that are affected by an event and that function as managers, and the network device comprises means for temporarily storing event reports transmitted to a manager device, means for receiving a request for re-transmission of lost event reports from the manager and means for retrieving and re-transmitting requested event reports to the manager.

According to a third embodiment of the invention, there is provided a network device functioning as a manager in a management network for monitoring and controlling a communications system, whereby the network device is designed for at least one manager-agent relationship with an agent device of one network management level and the network device of another management level as manager. The network device comprises means for receiving management information as event reports from an agent device of the management network that reports an event which affects the network device and comprises means for recognizing a loss of one or more event reports, for identifying the lost event reports and for requesting re-transmission of the lost event reports by sending a request to the agent.

According to a fourth embodiment of the invention, there is provided a communications system with a management network for monitoring and controlling a communications system comprising both a network device functioning as an agent according to the second embodiment of the invention and also a network management device functioning as a manager according to the third embodiment, configured as devices on different management levels.

According to a fifth embodiment of the invention, there is provided a computer readable storage medium comprising a computer program with code means for performing the method steps of one of the first embodiment relevant for a network device according to the second or third embodiment, when run on a processor.

According to a sixth embodiment of the invention, the agent can be capable to support multiple re-transmission requests sent by different registered managers at the same time, as the agent is capable to queue the requests and to perform them sequentially.

Embodiments of the present invention may have one or more of the following advantages:
Especially in case of short-time or mid-time interruptions of Manager-Agent (for example NMS-EMS/NE) communication, a significant reduction of synchronization time and interface payload, since full synchronization requests are avoided.
Applicability for both, reliable and unreliable, transport protocols
Optimization of needed buffer size in the agent, thereby improving the re-transmission capability as more event reports can be stored for re-transmission
Independency of the type of lost event report, the specific telecom network domains, the protocol used on management interfaces and the involved management levels (Element Management, Network Management or Service Management).

### BRIEF DESCRIPTION OF DRAWINGS

FIG. 1 shows the configuration of a management network which comprises managers and agents on different management levels with multiple manager agent relationships

FIG. 2 shows event buffer storage elements according to some exemplary embodiments of the invention, with event reports for multiple registered managers

FIG. 3 shows a flow chart describing the processing of an event to be reported and stored in the event buffer according to an exemplary embodiment of the invention

FIG. 4 shows exemplarily the communication between agent and manager for event reporting and re-transmission according to an embodiment of the invention, in the form of a message chart

FIG. 5 shows a schematic event buffer according to some embodiments of the invention

FIG. 6 shows a schematic event buffer and an empty swap buffer according to some embodiments of the invention

FIGS. 7a, 7b and 7c show an event buffer and a swap buffer in different stages of storing a new event during and after re-transmission processing

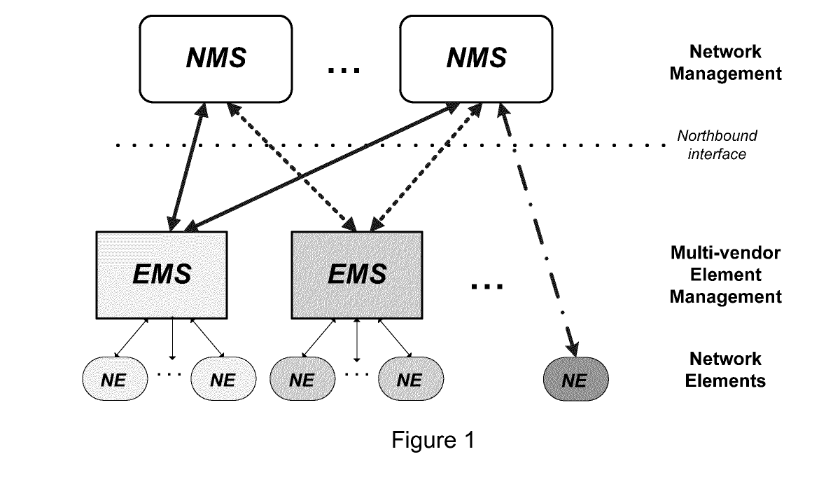

### DETAILED DESCRIPTION OF SOME EMBODIMENTS

Examples of the present invention are described herein below with reference to the accompanying drawings.

To achieve the objects of the invention, it provides means allowing the Managers (NMS) to recognize the loss of event reports.

For this purpose, each event report passing the manager-specific filter settings gets an unambiguous NMS-specific sequence identifier, which may be a steadily incremented number.

The range for a sequence identifier value may be 1 . . . Max (value 0 is used only for indicating an event report which has not passed the manager-specific filter settings), where MAX is a configurable value. In case this maximum value is reached, the next used value may again be 1.

The embodiments of the invention also provide means for storing temporarily a certain amount of events reports forwarded to the registered NMS for potential later re-transmission needs, i.e. an event buffer with entries consisting of the sequence identifiers and event report parameters corresponding to one event report (notification) already forwarded to one or several registered NMS.

Especially two aspects are taken into account:
A common logical buffer for all registered NMS may be used. Every event is stored only once in the common buffer, also in the case this event has been forwarded to several registered NMS.
The handling of new events occurred during the processing of event re-transmission triggered by one registered NMS

An event buffer following the ring buffer approach may be used.

The configurable storage size N of an event buffer may depend on one or more of the overall storage capacity of the agent system, the network size, the number of managing NMS and the expected rate of events to be forwarded on northbound interfaces.

Each entry in the common buffer represents one event report forwarded to at least one NMS and may consist of two components:

a) The entry header, consisting of the sequence identifier values (seqIdi) used for forwarding of the current event towards NMSi. For those NMS to which the event report has been filtered out, the sequence identifier value is 0 (this default value indicates that the event has not been forwarded to the related NMS).

b) The entry body, consisting of all event parameters.

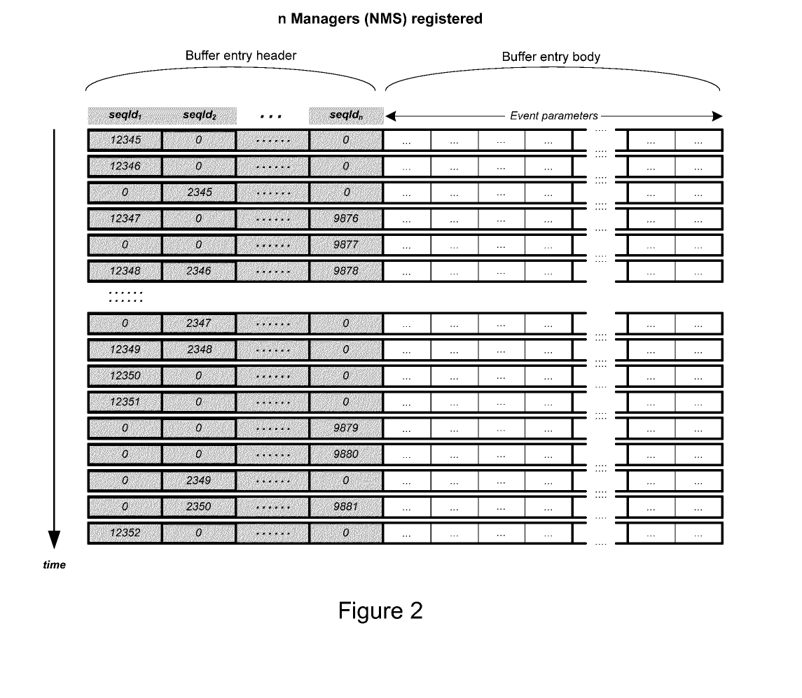

FIG. 2 shows exemplarily the logical event buffer structure in case of n registered NMS. The first event record with seqId1=12345 has been forwarded only to NMS1, the third event record with seqId2=2345 has been forwarded only to NMS2, while the fourth event record with seqId1=12347 and seqIdn=9876 has been sent to both NMS1 and NMSn.

A lost event report may be removed from the common event buffer when it has been retransmitted to all requiring NMS, without buffer full condition or when it is overwritten by a new event report due to buffer full condition.

During normal operation of the management interfaces the event buffer is full, in order to store as many event records as possible and to facilitate—as far as possible—the processing of re-transmission requests triggered by NMS recognizing the loss of one or several event reports.

It is possible that new events occur during the re-transmission of the oldest buffered event records. In order to avoid overwriting these old events before their re-transmission is successfully finished, additionally a so-called swap buffer can be used.

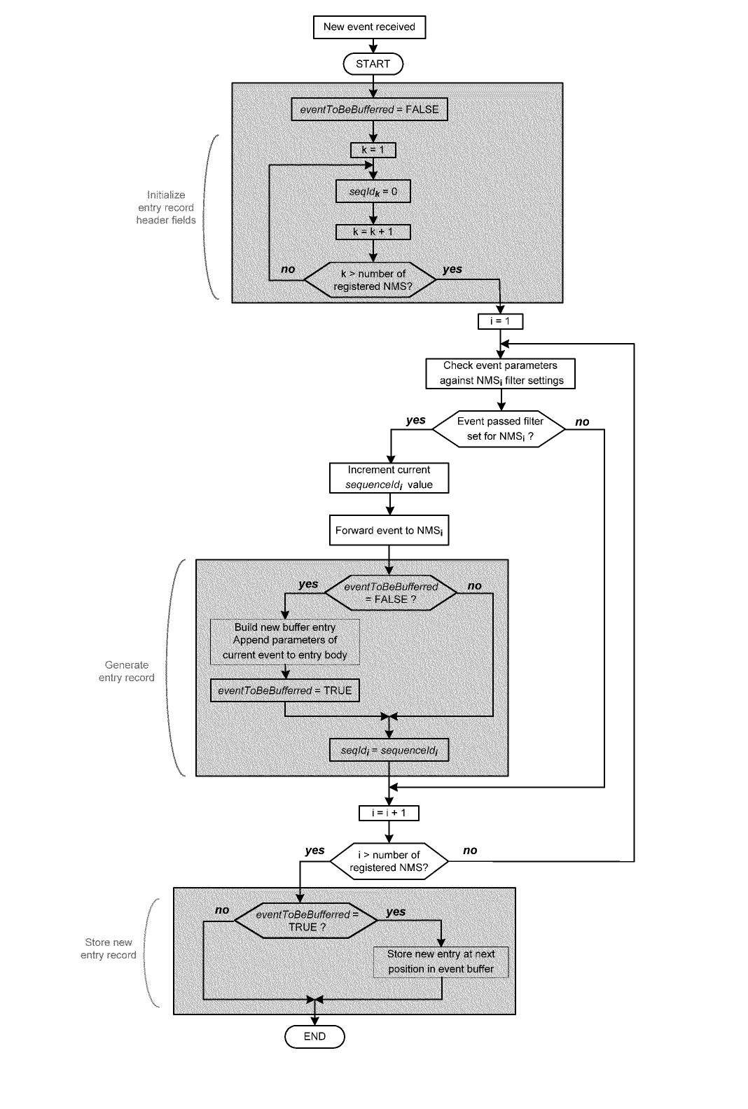

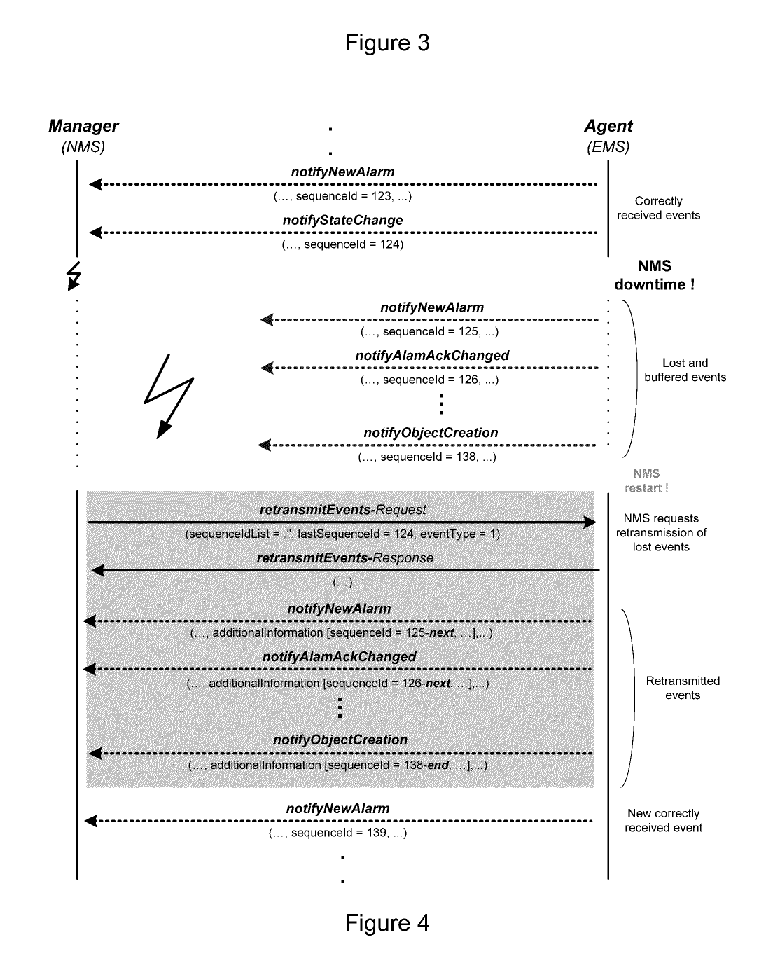

The algorithm shown in FIG. 3 describes how each new occurred event may be processed by the agent, and how the common event buffer may be populated.

The steps marked with shaded boxes indicate how a buffer entry may be generated and stored in the common buffer as far as the event is forwarded at least to one of the registered NMS.

Processing of an incoming event report:

a) Starting with first registered NMS, the new received event is tested against the NMS-specific filter settings

b1) If the event passed the filter, an unambiguous, NMS-specific sequence identifier value (sequenceIdi) is incremented and attached to the event report, which subsequently is forwarded to the manager (NMSi).

Depending on the used interface technology, the sequence identifier may be either a dedicated parameter of the forwarded notification (e.g. in case of a SNMP-based interface) or—in case of event reports with a standard-defined syntax (like for 3GPP CORBA-based or TMF MTOSI SOAP-based interfaces)—it may be included in one of the generic notification parameters e.g. additionalText or additionalInformation.

In addition, a related event record (buffer entry) is either generated (for the first NMS to which the event passed the filter) or updated (for all further NMS to which the event passes the filter), i.e. the related sequence identifier value in the header is set to the corresponding sequenceIdi for the current NMS.

b2) If the event does not pass the filter, the processing continues with item c) below.

c) The procedure is repeated for the next registered NMS, until the event is tested against the filter settings of all registered NMS. If the event passed the filter of at least one of the NMS, the prepared event record is then inserted in the event buffer.

Processing of event report re-transmission in case of management interfaces based on unreliable transport protocols (e.g. SNMP) mainly uses the fact that every event report forwarded to an NMS has an unambiguous (NMS-specific) sequence identifier value as a notification parameter.

The manager easily discovers possible gaps between two consecutive received messages and can subsequently indicate in the re-transmission request to the agent the list of dedicated (lost) event records to be sent again.

In case of management interfaces based on reliable transport protocols (e.g. 3GPP CORBA), each event report forwarded to a NMS contains an unambiguous (NMS-specific) sequence identifier value in the parameter additionalText or additionalInformation or a similar parameter of the notification.

For these interfaces the loss of events usually occurs in case of short-time interruption of the communication between manager and agent, due to NMS downtime. After re-establishment of the communication, the NMS can and may indicate in the re-transmission request to the agent the sequence identifier value of the last received one event record. The agent will use the information stored in the event buffer to send all event records generated after the indicated one.

In both above cases, if the required information is not completely available in the event buffer anymore, the NMS request may be rejected with a corresponding error reason. Only in this case a full synchronization of the needed management information may be needed by a manager.

For re-transmission of lost events a new operation retransmitEvents with the following input parameters may be used for both management interface types based on reliable or unreliable transport protocols:
sequenceIdList: It indicates a list of sequence identifiers for lost events as a range in format “<start sequenceId>-<end sequenceId>” and/or as an array of single sequenceId values separated by a configurable character. This parameter shall be used when there is a gap between the sequence identifier values of two consecutive received event reports or in case of a list of single lost event reports (typical usage case for unreliable transport protocols).
lastSequenceId: It indicates the sequence identifier value of the last received event. This parameter shall be used after interruption and re-establishment of the manager-agent communication (typical usage case for reliable transport protocols, see as an example FIG. 4).
eventType: It indicates the type of lost events to be re-transmitted (e.g. 1=all events, 2=only alarm-related events etc.). In some cases one manager may be interested only in dedicated event types occurred during interface downtime and not in all lost events.

Every retransmitted event report contains its sequence identifier and may also contain an annotation (e.g. next or end), offering to the manager the capability to recognize the end of re-transmission process.

FIG. 4 shows as example a message exchange between manager (NMS) and agent (EMS) for event re-transmission. (marked in shaded background), after the re-establishment of communication in case of a CORBA-based management interface. The NMS request indicates that the last received event report before communication interruption had the sequenceId value 124.

For NMS-triggered re-transmission requests a common event buffer and a swap buffer may be used.

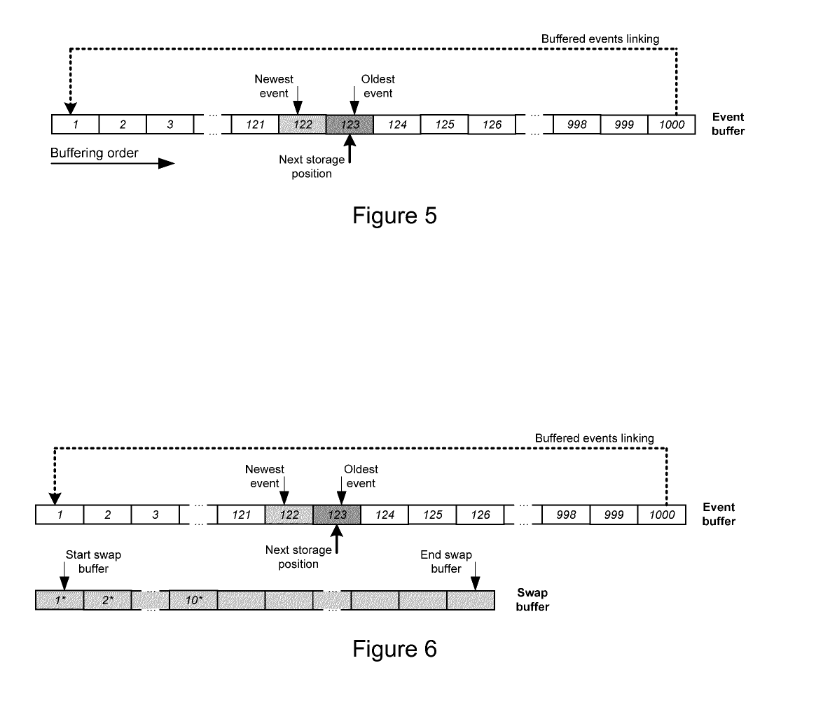

As mentioned above, the common buffer may follow the ring buffer approach and its handling may require the permanent administration of two pointers as shown in FIG. 5:
Newest event
Oldest event (which indicates the storage position of the next event to be received)

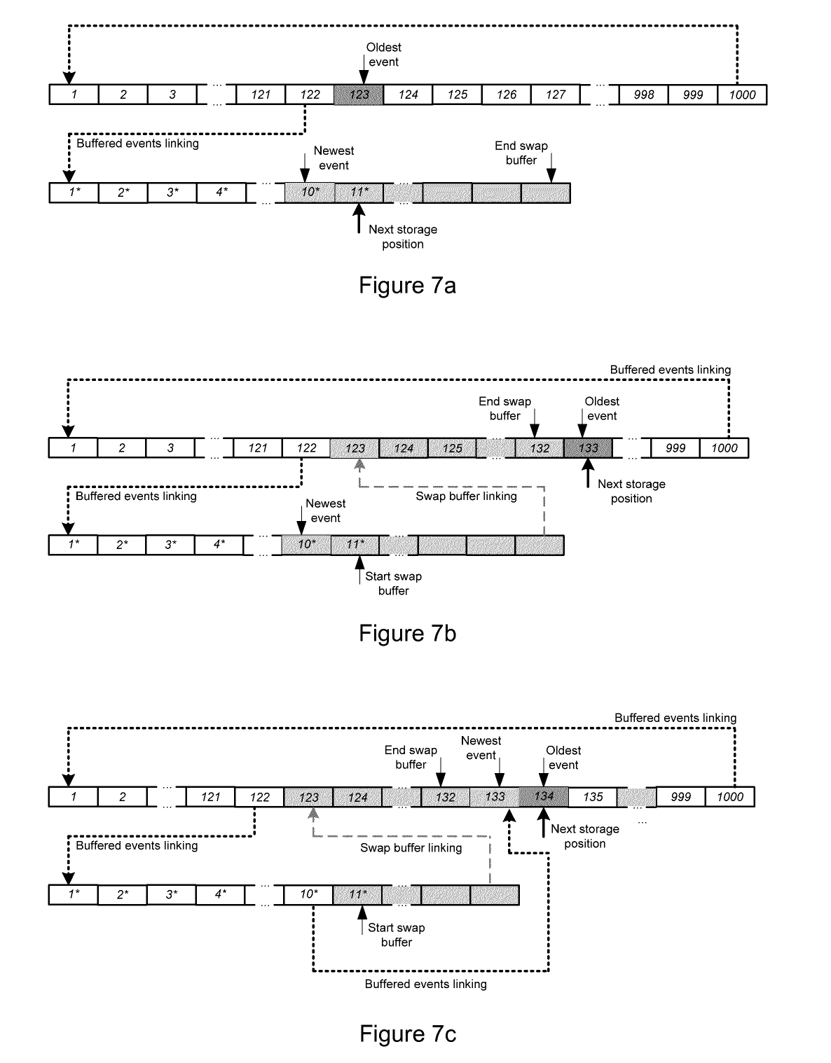

Note that for exemplification purposes, in the FIGS. 5 to 7 c the capacity of the common event buffer is 1000 event records. The numbers 1, 2, 3 . . . represent the index position in the event buffer, while 1*, 2*, 3* in FIGS. 6 to 7c represent the index position in the swap buffer (but not any sequence number).

During the processing of an NMS-triggered re-transmission request involving the oldest events stored in the event buffer, it is possible that new incoming events would overwrite the oldest one, i.e. the re-transmission would fail. In order to avoid this, a swap buffer may be used in conjunction with the event buffer (FIG. 6).

The size of the swap buffer shall cover the number of relevant events (i.e. events that pass the current filter settings) which may occur during the time period between the reception of manager request and the end of event re-transmission processing. In the case also the swap buffer would become full (which implies that buffered events required for re-transmission are overwritten by new incoming ones), the manager request can be rejected with a corresponding error reason. Subsequently the manager may have to trigger full synchronization of management data.

FIG. 7a shows a state of event and swap buffer where after reception of a manager re-transmission request, 10 new events passed the filter of at least one of the registered managers. In order to avoid a possible overwriting of the oldest entries in the event buffer during the re-transmission request processing, these new events are stored in the swap buffer, i.e. the oldest events in common buffer can still be maintained.

FIG. 7b shows a state of event and swap buffer at the end of event re-transmission processing. The oldest events in common buffer are made unavailable by moving correspondingly the logical position of the “end swap buffer” index, i.e. the initial capacity of both event buffer and swap buffer is restored.

FIG. 7c shows the next configuration of event buffer and swap buffer after one new received event has been forwarded to one or more managers.

As recognized in FIG. 7a, within the time interval between reception of a re-transmission request and the end of re-transmission processing, the “Oldest event” and “Next storage” positions may point to different locations (as far as new events are buffered during this time period). Outside this small time interval the “Oldest event” and “Next storage” positions are identical.

In the case a further manager asks for re-transmission of buffered events before the processing of a previous re-transmission request is finished, the agent may first queue the second request and execute it afterwards.

The event buffer can store the last N forwarded events, independently of the fact whether these events are relevant for one or more registered managers. Because each manager may set own filter settings, at one point of time different amounts of buffered event records are available for re-transmission with regard to different managers. Depending on the manager-specific rate of received events (filter dependent) and on possible manager's downtime, there are different chances among the registered managers to find the whole amount of lost events in case of re-transmission needs. In any case the proposed mechanisms in this invention ensure that the manager with the highest received events rate has also the most stored event records in the event buffer.

List of abbreviations:
3GPP 3rd Generation Partnership Program
EM Element Management
EMS Element Management System (Element Manager)
IRP Integration Reference Point
NE Network Element
NM Network Management
NMS Network Management System (Network Manager)
OMC Operations and Maintenance Centre
SNMP Simple Network Management Protocol
TMN Telecommunication Management Network

Embodiments of the present invention may be implemented in software, hardware, application logic or a combination of software, hardware and application logic. The software, application logic and/or hardware may reside on one or more network elements, network devices or network apparatuses. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

Reference signs in the claims are added to show how the claims could be mapped to the example embodiments and are not limiting the scope of protection of the claims.

1. Method for re-transmission of management information in a management network for monitoring and controlling a communications system, comprising:
storing, by an agent (EMS), temporarily event reports transmitted by the agent to a manager (NMS) for future re-transmissions;
recognizing, by the manager, a loss of one or more event reports, identifying, by the manager, the lost event reports and requesting, by the manager, re-transmission of the lost event reports by sending a request to the agent; and
retrieving, by the agent, the requested event reports from storage and re-transmitting the event reports to the requesting manager.

2. Method according to claim 1, further comprising assigning to an event report a consecutively increasing sequence identification number (seqIDi), which is unique for each manager, and transmitting the sequence identification number with the event report to the manager.

3. Method according to claim 1, wherein the recognizing comprises detecting a gap in the sequence of sequence identification numbers (seqIDi) received from the agent and wherein the identifying comprises deriving the sequence numbers of lost transmission reports from the gap.

4. Method according to claim 1, wherein the requesting comprises indicating the sequence identification numbers (seqIDi) of lost event reports.

5. Method according to claim 1, wherein the requesting comprises indicating the sequence identification number (seqIDi) of the last received event report after a communication failure.

6. Method according to claim 1, wherein the requesting comprises indicating a subset, type or class of event reports which shall be re-transmitted.

7. Method according to claim 1, wherein the requesting comprises indicating a subset, type or class of event reports which shall not be re-transmitted.

8. Method according to claim 1, further comprising storing by the agent the event report in an event buffer storage element, once for multiple managers to which the event report has been transmitted, whereby the event buffer storage element comprises a sequence identification number (seqIDi) for each manager to which the event report has been transmitted.

9. Method according to claim 8, wherein the event buffer storage elements are managed in a data structure with pointers to the newest and oldest elements.

10. Method according to claim 9, wherein the data structure is a ring buffer structure, whereby a new event report is stored in the element after the newest element and the oldest element is overwritten cyclically, when the ring buffer is full.

11. Method according to claim 10, wherein a new event report is stored in a swap buffer element instead of overwriting the oldest element, while the event report of the oldest element is requested for re-transmission by a manager and the re-transmission is not yet completed.

12. Method according to claim 1, wherein the management network comprises managers (NMS) and agents (EMS) on different management levels (NM LEVEL, EM LEVEL), whereby management information is transmitted as event reports between these devices (NMS, EMS) of the management network.

13. Network device functioning as an agent (EMS) in a management network for monitoring and controlling a communications system, comprising:
means for transmitting management information as event reports to devices (NMS) of the management network that are affected by an event and that function as managers,
wherein the network device (EMS) comprises means for temporarily storing event reports transmitted to a manager device (NMS), means for receiving a request for re-transmission of lost event reports from the manager and means for retrieving and re-transmitting requested event reports to the manager.

14. Network device of claim 13 whereby the network device (EMS) is arranged for at least one manager-agent relationship with a manager device (NMS) of one network management level (NM LEVEL) and the network device (EMS) as agent of another management level (EM LEVEL).

15. Network device functioning as a manager (NMS) in a management network for monitoring and controlling a communications system, comprising:
means for receiving management information as event reports from an agent device (EMS) of the management network that reports an event which affects the network device, wherein the network device comprises means for recognizing a loss of one or more event reports, means for identifying the lost event reports and means for requesting re-transmission of the lost event reports by sending a request to the agent.

16. Network device of claim 15 whereby the network device (NMS) is arranged for at least one manager-agent relationship with an agent device (EMS) of one network management level (EM LEVEL) and the network device (NMS) of another management level (NM LEVEL) as manager.

17. A system, comprising:
a network device (EMS) functioning as an agent according to claim 13; and
a network device functioning as a manager (NMS) in a management network for monitoring and controlling a communications system, comprising means for receiving management information as event reports from an agent device (EMS) of the management network that reports an event which affects the network device, wherein the network device comprises means for recognizing a loss of one or more event reports, means for identifying the lost event reports and means for requesting re-transmission of the lost event reports by sending a request to the agent,
said network device and said network management device being configured as devices on different management levels (EM LEVEL, NM LEVEL).

18. A method of monitoring and controlling a communications system, comprising:
transmitting management information as event reports to devices (NMS) of the management network that are affected by an event and that function as managers, temporarily storing event reports transmitted to a manager device (NMS), receiving a request for re-transmission of lost event reports from the manager and retrieving and re-transmitting requested event reports to the manager.

19. A method of monitoring and controlling a communications system, comprising:
receiving management information as event reports from an agent device (EMS) of the management network that reports an event which affects the network device, recognizing a loss of one or more event reports, identifying the lost event reports and requesting re-transmission of the lost event reports by sending a request to the agent.

20. A computer readable storage medium comprising a computer program with code means for performing the method steps of claim 1 when run on a processor.
